(19) United States
(12) Patent Application Publication
(10) Pub. No.: US 2021/0319527 A1
(43) Pub. Date: Oct. 14, 2021

(54) FRAUD DETECTION DURING AN APPLICATION PROCESS

(71) Applicant: Capital One Services, LLC, McLean, VA (US)

(72) Inventors: Abdelkader M'Hamed BENKREIRA, New York, NY (US); Daniel MARSCH, Arlington, VA (US); Andrea MONTEALEGRE, Arlington, VA (US); William PRIOR, Richmond, VA (US); Nagaraju GADDIGOPULA, Herndon, VA (US); Phoebe ATKINS, Brooklyn, NY (US)

(21) Appl. No.: 16/848,420

(22) Filed: Apr. 14, 2020

(51) Int. Cl. G06Q 50/26; G06Q 10/10; G06Q 40/02; G06N 20/00; H04W 12/06; H04L 29/06; H04L 12/46; H04L 29/08; G06F 3/0485; H04L 29/12

(52) U.S. Cl. CPC G06Q 50/265; G06Q 10/10; G06Q 40/025; G06N 20/00; H04W 12/06; H04L 67/18; H04L 12/4641; H04L 67/42; H04L 67/22; G06F 3/0485; H04L 61/2007; H04L 63/08

(57) ABSTRACT

A system may receive, from a server device that provides an application form to a client device, device information associated with the client device, wherein the device information indicates a geolocation associated with the client device. The system may receive, from the server device, behavior information that indicates user behavior associated with inputting data into the application form using the client device, wherein the behavior information indicates a manner in which the data is input into one or more fields of the application form. The system may determine a fraud score based on the device information and the behavior information. The system may transmit an indication of a recommended action to be performed by the server device with respect to the application form and the client device based on the fraud score.

### BACKGROUND

Fraud detection involves actions taken to prevent undesirable access to a user's data or property through fraud. Fraud may involve an imitation of the user's identity by a fraudulent actor. The fraudulent actor typically gains access to some or all of the user's authentication information through undesirable means and uses the authentication information to imitate the user's identity. The fraudulent actor may pose as the user and gain access to information, property, services, and/or the like associated with the user.

### SUMMARY

According to some implementations, a method may include receiving, by a system and from a server device that provides an application form to a client device, device information associated with the client device, wherein the device information indicates a geolocation associated with the client device; receiving, by the system and from the server device, behavior information that indicates user behavior associated with inputting data into the application form using the client device, wherein the behavior information indicates a manner in which the data is input into one or more fields of the application form; determining, by the system, a fraud score based on the device information and the behavior information, wherein the fraud score is determined using a machine learning model that identifies patterns from the device information and the behavior information; and transmitting, by the system, an indication of a recommended action to be performed by the server device with respect to the application form and the client device based on the fraud score.

According to some implementations, a device may include one or more memories; and one or more processors, communicatively coupled to the one or more memories, configured to: determine device information associated with a client device used to provide input for an application form, wherein the device information is determined based on an Internet Protocol (IP) address of the client device; determine behavior information that indicates user behavior associated with inputting data into the application form using the client device, wherein the behavior information indicates user input dynamics used to input the data into one or more fields of the application form or to navigate between fields of the application form; provide the device information and the behavior information as a feature set that is input to a machine learning model; receive output from the machine learning model; and cause a recommended action to be performed with respect to the application form and the client device based on the output from the machine learning model.

According to some implementations, a non-transitory computer-readable medium may store one or more instructions. The one or more instructions, when executed by one or more processors of a device, may cause the one or more processors to: receive device information associated with a client device used to provide input to a form, wherein the device information includes information used for communication between the client device and a server device that provides the form to a client device receive behavior information that indicates user behavior associated with inputting data into the form using the client device, wherein the behavior information indicates user input dynamics used to input the data into one or more fields of the form or to navigate between fields of the form; generate a feature set based on the device information and the behavior information; determine a fraud score based on a degree of similarity of the feature set and one or more other feature sets associated with labeled instances of fraud or associated with the form; and cause a recommended action to be performed with respect to the form and the client device based on the fraud score.

### BRIEF DESCRIPTION OF THE DRAWINGS

FIGS. 1A-3 are diagrams of one or more example implementations described herein.

FIG. 4 is a diagram of an example environment in which systems and/or methods described herein may be implemented.

FIG. 5 is a diagram of example components of one or more devices of FIG. 4.

FIGS. 6-8 are flowcharts of example processes for fraud detection during an application process.

### DETAILED DESCRIPTION

The following detailed description of example implementations refers to the accompanying drawings. The same reference numbers in different drawings may identify the same or similar elements.

Fraud detection involves actions taken in an attempt to successfully identify fraud. Fraud may occur in many different forms, including a scenario where a fraudulent actor uses deceit to assume another identity. Assuming another identity may allow the fraudulent actor to gain access to secure areas accessible by the original identity holder. These secure areas may include both physical areas (such as buildings, vehicles, and/or the like), and nonphysical areas (such as bank accounts, website access, and/or the like).

To successfully assume a user's identity, the fraudulent actor may acquire the user's authorization information, such as a user's birthdate, social security number, password, and/or the like, which is typically assumed to be accessible by only the user. The fraudulent actor may acquire the user's authorization information through illegitimate means and pose as the user to gain access to information, property, services, and/or the like associated with the user.

Through technological advances, traditionally offline transactions have become digital (e.g., paying bills online, purchasing goods through an application, and/or the like). Fraud may be common in digital transactions because digital transactions may rely on text-based authentication information (e.g., passwords, social security numbers, birthdates, and/or the like) to determine a user's identity. Therefore, a fraudulent actor who is able to gain access to the text-based authentication information may be able to pose as the user and gain undesirable access to the user's information. This contrasts with in-person transactions, where non-text-based authentication information (e.g., comparing a photo on a driver's license to the person submitting the driver's license to ensure identity, and/or the like) may also serve as authentication information that is less easily imitated.

For example, a provider (e.g., a service provider, merchant, financial institution, and/or the like) may use digital application forms that allow users to apply for a particular service without having to appear in-person at an on-site provider location. If a fraudulent actor has acquired some or all of the user's authentication information required to complete the application form, the fraudulent actor may exploit the user's identity and apply for the particular service using the user's identity. For example, the fraudulent actor may apply for a transaction card (e.g., a credit card, a debit card, a rewards card, and/or the like) as the user.

These fraudulent activities may negatively impact both the user and provider. The user may be liable for transactions that arose through the fraudulent actor and may attempt to identify and remedy the fraudulent transactions. For example, the user may object to the fraudulent activity, such as contesting the application, actions that arise out of the application, and/or the like. This may waste computing resources associated with a service, because the computing resources are used to attempt to identify and remedy the fraudulent activity. The provider may also be negatively impacted and waste computing resources associated with attempting to reverse the fraudulent activity for the user, along with attempting to identify, detect, and diagnose the fraudulent activity.

Some implementations described herein provide a fraud platform (e.g., a fraud detection platform) that detects fraud by analyzing device information and behavior information associated with a user entering input into an application form. The fraud platform may determine a fraud score based on the device information and the behavior information and transmit an indication of a recommended action to be performed based on the fraud score. The behavior information may indicate a manner in which data is input into one or more fields of the application form (e.g., a keystroke speed, scrolling behavior, copy and pasting behavior, and/or the like), which may be used in conjunction with the device information (e.g., information indicating whether a virtual private network was used, a geolocation associated with a user, cookies, and/or the like) to uniquely identify a user. In this way, attributes of the user other than text-based information (which may be easily compromised) may be used to detect fraud. A fraudulent actor may have difficulty imitating behavior information and/or device information, or illegitimately acquiring behavior information and/or device information. This may result in accurate fraud detections, because the fraudulent actor will fail to successfully imitate the behavior information and/or the device information. This, in turn, saves computing resources used in conjunction with identifying, diagnosing, and remedying fraudulent activity after the fact (e.g., after the fraudulent activity occurs). For example, computing resources used to reverse a transaction that resulted from a fraud may be saved.

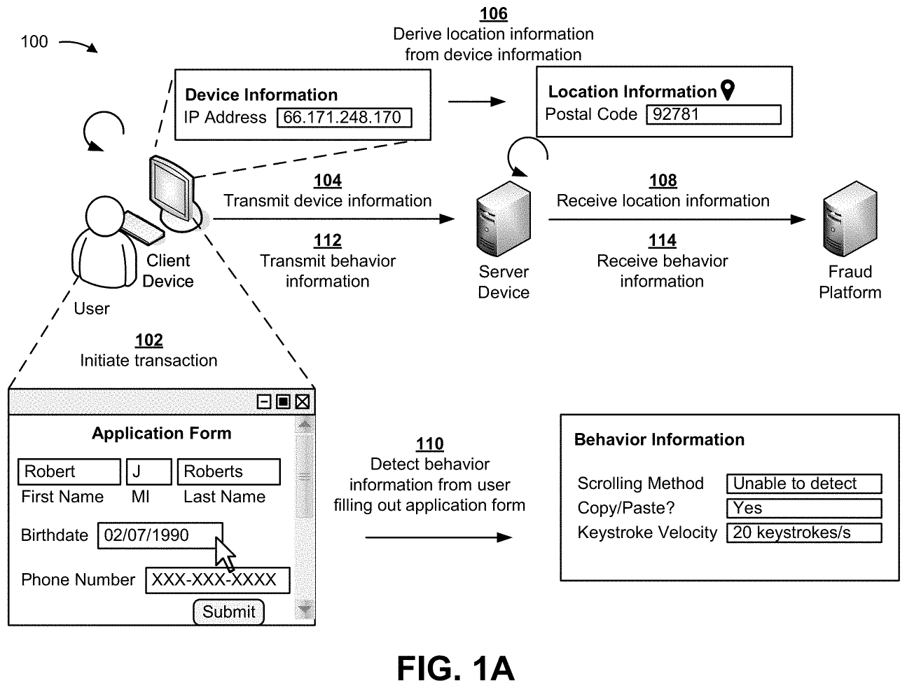

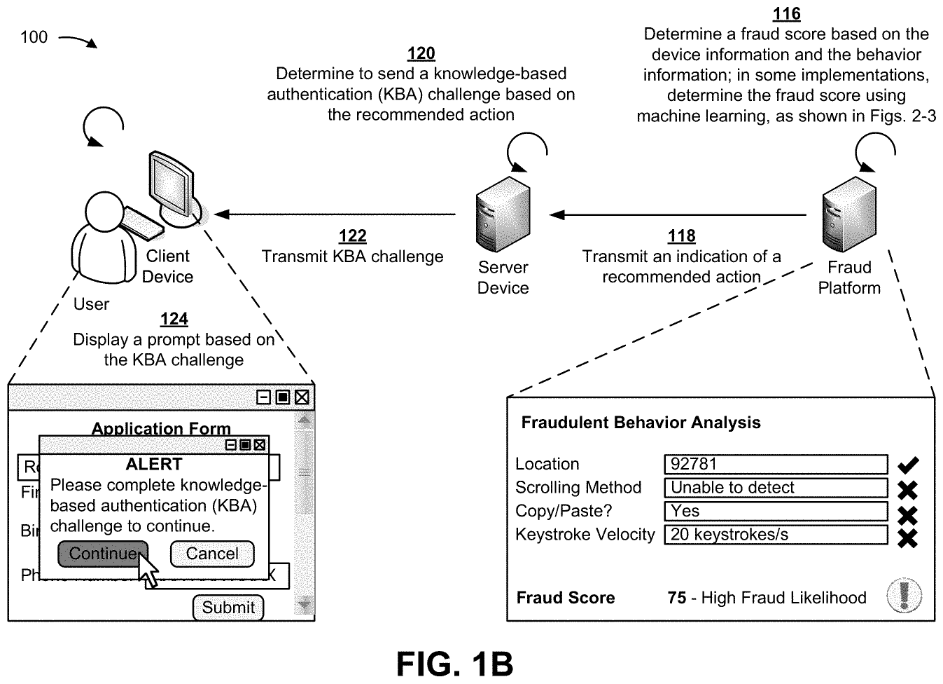

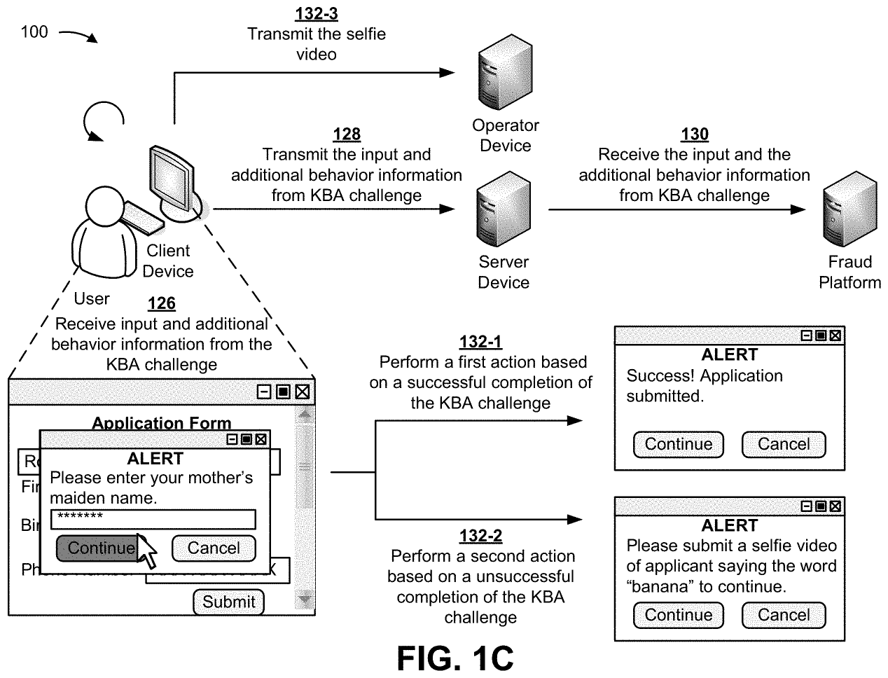

FIGS. 1A-1C are diagrams of one or more example implementations 100 described herein. As shown in FIG. 1A, a client device may be associated with a user, a server device, and a fraud platform. The user of the client device may interact with the client device to conduct a transaction (e.g., submitting an application form) with a server device. The server device may be configured to send and receive information from the fraud platform, which determines a fraud score based on analyzing information received by the fraud platform. The server device may transmit information to the client device based on recommended actions from the fraud platform.

As shown in FIG. 1A, and by reference number 102, a user may use a client device to initiate a transaction associated with a server device. For example, the user may use the client device to interact with (e.g., view, fill, complete, and/or the like) an application form. The application form may be connected with a service associated with the server device and the application form may be provided to the client device from the server device. The application form may be viewed on a webpage, application, and/or the like.

In some implementations, the application form may have blank fields for the user to input information into. The application form may be navigable through different means, such as moving a cursor, scrolling, tabbing, using keyboard shortcuts, and/or the like. The user may use different techniques for each means. For example, the user may scroll using a mouse wheel, using a trackpad, using a touch screen, a combination of scrolling techniques, and/or the like; the user may move from field-to-field using the “tab” key, keyboard shortcuts, moving a mouse cursor, a combination of field navigating techniques, and/or the like; the user may move a cursor using a track pad, using a touch screen, using a mouse, using a combination of cursor moving techniques, and/or the like; the user may input text using a physical keyboard, a touchscreen keyboard, using copy and paste, a voice command, a combination of text input techniques; and/or the like. While some common behaviors associated with interacting with an application form are listed above, some implementations described herein are not limited to these behaviors.

As shown in FIG. 1A, and by reference number 104, the client device may transmit device information associated with the client device to the server device. The device information may indicate various information associated with the client device or the user. For example, the device information may include an internet protocol (IP) address, location information, and/or the like. In some implementations, the device information may include network information, such as whether the client device communicates with the server device via a virtual private network (VPN), a type of VPN used by the client device to communicate with the server device, a network route that carries traffic between the client device and the server device, one or more network devices included in the network route, whether the network route includes an anonymity network exit node, an internet service provider (ISP) associated with the client device, one or more cookies installed on the client device, one or more software applications installed on the client device, and/or the like. In some implementations, the device information may include information about the client device, such as what type of client device is being used, what operating system (e.g., a type and/or version of operating system) the client device is running, a device identifier associated with the client device, and/or the like. Additionally, or alternatively, the device information may include information identifying a web browser (e.g., a type and/or version of web browser) used by the client device to access the application form. The examples for device information are listed merely as illustrative examples, and are not intended to limit the scope of what may be considered to be device information.

As shown in FIG. 1A, and by reference number 106, the server device may derive information from the device information. For example, the server device may derive location information (e.g., an area code, geographic coordinates, a postal code, and/or the like) from an IP address. In some implementations, the device information may include location information, and the server device may determine additional location information, differently formatted location information, and/or the like from the device information. For example, the location information may include a latitude coordinate, a longitude coordinate, and altitude information associated with the client device. While the figures show the server device performing this determination, location information may be derived by another device, such as the client device, the fraud platform, or a third party server. In some implementations, the device information may be derived by the client device, the server device, or the fraud platform, based on information received. As shown in FIG. 1A, and by reference number 108, the fraud platform may receive the location information. The fraud platform may use the location information in determining whether there is a likelihood of fraud associated with the transaction.

As shown in FIG. 1A, and by reference number 110, the client device may detect behavior information from the user interacting with the application form. The behavior information may indicate user behavior associated with inputting data into the application form using the client device. The behavior information may be associated with obtaining data from behaviors (as noted above) associated with the user interacting with the application form. For example, behavior information may include one or more of: keystroke dynamics, mouse dynamics, a field-navigating technique, a scrolling technique, a text input technique, and/or the like. Keystroke dynamics may include information indicating a velocity of keystrokes, an acceleration of keystrokes, and/or the like associated with the user input. Mouse dynamics may include information indicating a type of mouse movement, a velocity of mouse movement, and/or the like associated with the user input. A field-navigating technique may include information indicating what technique is used to navigate between fields, a speed associated with navigating between fields, and/or the like. A scrolling technique may include a type of scrolling used to navigate the application form. A text input technique may include a speed of text input, a detection of how text is inputted, and/or the like associated with the user input. The behavior information may be gathered through sensors on the client device.

In some implementations, behavior information may include timing information (e.g., time associated with completing an application, time associated with a user input technique, and/or the like). In some implementations, behavior information may be collected for both large- and small-scale behaviors. For example, behavior information may include time taken to fill out one particular field (a small-scale behavior), time taken to fill out an entire application form (e.g., a large-scale behavior), and/or the like.

As shown in FIG. 1A, and by reference number 112, the client device may transmit the behavior information to the server device. The client device may transmit the behavior information to the server device upon completion of the application form (e.g., when the user clicks a “submit” button, when the client device detects the user has finished the application form, and/or the like). In some implementations, the client device may transmit the behavior information upon a predetermined act (e.g., completion of a particular field, completion of a particular percentage of the application form, selection of a “save” button, and/or the like). In some implementations, the client device may transmit the behavior information based on timing information (e.g., based on a particular time interval, based on a particular time of day, and/or the like).

As shown in FIG. 1A, and by reference number 114, the fraud platform may receive the behavior information from the server device. In some implementations, the server device may perform processing before sending the behavior information to the fraud platform. This may include aggregating the behavior information with other behavior information, formatting the behavior information, and/or the like to assist the fraud platform in processing the behavior information.

As shown in FIG. 1B, and by reference number 116, the fraud platform may determine a fraud score based on the device information and the behavior information. A fraud score may indicate a likelihood that the user who is associated with the behavior information or the device information is committing fraud (e.g., a high fraud score indicates a high likelihood of fraud, a low fraud score indicates a low likelihood of fraud, and/or the like). A fraud score may be determined in various ways. In some implementations, the fraud platform may compare device information and/or behavior information and past device information and/or past behavior information associated with the user. Device information and/or behavior information that is different from the past device information and/or the past behavior information for the user may be indicative of fraud. For example, if past information indicates a user's keystroke velocity to be slow, and the behavior information indicates the user's keystroke velocity is fast, the fraud platform may associate the user's keystroke velocity with fraud. In another example, if the device information indicates a location that is different than past information provided by the user (e.g., an area code provided by the user in a previous application form, a location previously associated with the user, and/or the like), the fraud platform may associate the device information with fraud. In some implementations, some device information and/or behavior information may indicate fraud for any user. For example, using a virtual private network, copy and pasting information in some fields, and/or the like may be actions indicative of fraud for any user. Additionally, or alternatively, an ISP obtained from the device information may be compared against a list of ISPs that are known to be commonly correlated with fraud. If the ISP matches an ISP on the list, the fraud platform may determine that the device information is indicative of fraud. In some implementations, the fraud platform may associate particular types of behavior information and/or device information with fraud based on processing behavior information and/or device information from other users.

In some implementations, the fraud platform may determine user attributes from the device information and/or the behavior information. The user attributes may indicate various information associated with the user such as: a current location associated with the user, a scrolling method associated with the user, a keystroke velocity associated with the user, a field-navigating technique associated with the user, and/or the like. Some user attributes may have a high potential to accurately indicate fraud, while some user attributes may have a low potential to accurately indicate fraud. The fraud platform may analyze and combine determinations for each user attribute to determine the fraud score. Depending on how the user attribute is weighted, one potentially fraudulent user attribute may not outweigh many nonfraudulent user attributes, one potentially fraudulent user attribute may outweigh many nonfraudulent user attributes, and/or the like.

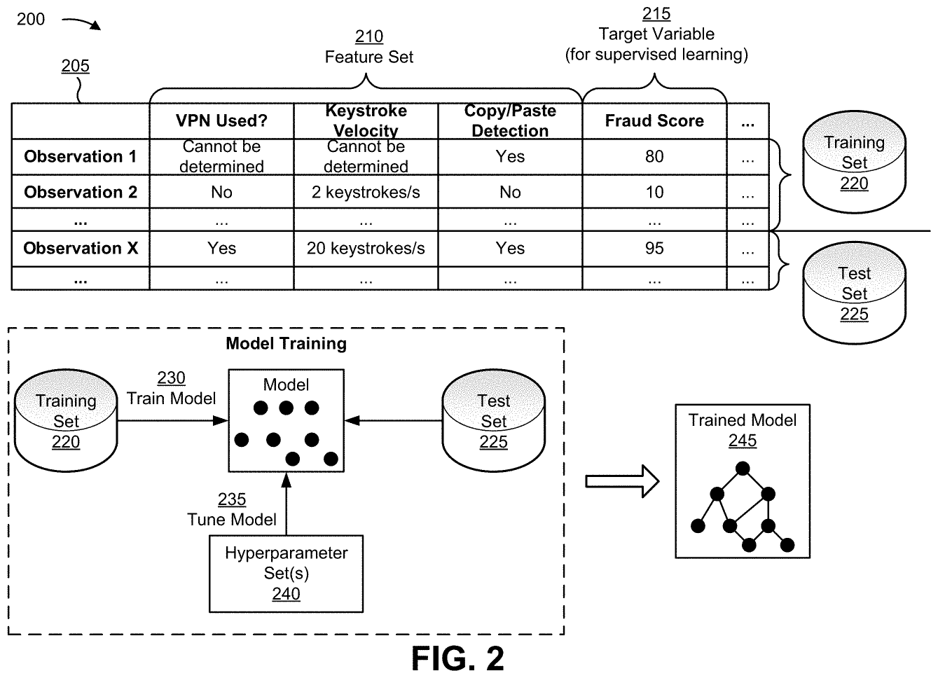

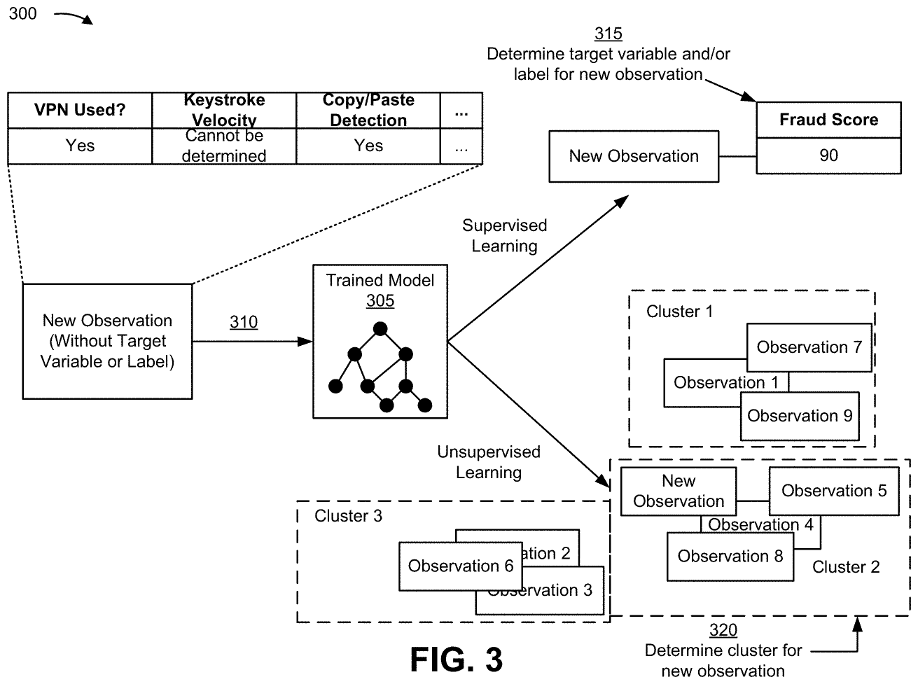

In some implementations, the fraud platform may use machine learning to determine the fraud score. For example, the fraud platform may use machine learning to determine whether a user attribute is indicative of fraud, use machine learning to determine how to assign a weight to the user attribute, and/or the like. This is described below in relation to FIGS. 2-3.

Based on the fraud score, the fraud platform may determine a recommended action. Recommended actions may include approving an application associated with the application form, rejecting the application associated with the application form, requesting additional information from the client device, sending an authentication challenge (e.g., a knowledge-based authentication (KBA) question, a video review action, a biometric step-up action, and/or the like), and/or the like. The recommended action may be used to obtain additional information on whether to authenticate the user and/or gain more information on whether the transaction is fraudulent. For example, for fraud scores highly indicative of fraud (e.g., high fraud scores, fraud scores that satisfy a particular threshold, and/or the like), the fraud platform may determine to send an additional authentication challenge to the client device, deny the application form, and/or the like. For fraud scores not highly indicative of fraud (e.g., low fraud scores, fraud scores that fail to satisfy a particular threshold, and/or the like), the fraud platform may determine to authenticate the user. As shown in FIG. 1B, and by reference number 118, the fraud platform may transmit an indication of the recommended action based on the fraud score.

As shown in FIG. 1B, and by reference number 120, the server device may determine to perform the recommended action based on receiving the indication of the recommended action from the fraud platform. For example, the server device may determine to send a KBA challenge based on the recommended action. The KBA challenge may include a static or dynamic KBA challenge. For example, a static KBA challenge may include a knowledge-based prompt, such as “What is your mother's maiden name?,” “What is your anniversary date?,” and/or the like, that was previously shared between the service and the user. A dynamic KBA challenge may include a knowledge-based prompt that is generated in real-time. For example, the dynamic KBA challenge may include questions generated from data records (e.g., marketing data, credit reports, transaction history, and/or the like) associated with the user. While the figures illustrate a KBA challenge, the challenge can be any type of authentication challenge, verification method, and/or the like.

As shown in FIG. 1B, and by reference number 122, the server device may transmit the KBA challenge to the client device. This may cause the client device to display the KBA challenge. In some implementations, as stated above, the KBA challenge may be transmitted after completion of the application form, during the completion of the application form, and/or the like. As shown in FIG. 1B, and by reference number 124, the client device may display a prompt based on the KBA challenge. The user may be required to answer the KBA challenge to proceed with the application form.

As shown in FIG. 1C, and by reference number 126, the client device may receive input to the KBA challenge. The input may include an answer to the KBA challenge. In some implementations, the client device may receive additional behavior information associated with the KBA challenge. The additional behavior information may include the types of behavior information described above, in relation to FIG. 1A.

As shown in FIG. 1C, and by reference number 128, the client device may transmit the input and the additional behavior information from the KBA challenge to the server device. In this way, the server device may analyze the input and/or additional behavior information to determine an action in response to the input. For example, the server device may analyze the input to verify if the input is correct, matches information previously inputted, and/or the like. In some implementations, the server device may process (e.g., perform a preprocessing operation) the input and/or additional behavior information to assist another device (e.g., the fraud platform, an authentication server, and/or the like) in processing the input and/or additional behavior information.

As shown in FIG. 1C, and by reference number 130, the fraud platform may receive, from the server device, the input and the additional behavior information from the KBA challenge. The fraud platform may determine if the input and the additional KBA challenge are indicative of fraud. Similar to what was described in connection with FIG. 1B, the fraud platform may determine a fraud score for the KBA challenge input, adjust the fraud score that was previously determined, and/or the like.

In some implementations, based on determining the fraud score, the fraud platform may determine a recommended action. The recommended action may include those previously described in relation to FIG. 1B (e.g., approving an application associated with the application form, rejecting the application associated with the application form, requesting additional information from the client device, sending an authentication challenge (e.g., a knowledge-based authentication (KBA) question, a video review action, a biometric step-up action and/or the like), and/or the like). Similar to what was described above in relation to FIG. 1B, the fraud platform may send the fraud score (e.g., the updated fraud score, a new fraud score, and/or the like) and/or an indication of a recommended action based on the fraud score to the server device. Based on this, the server device may determine to send information to the client device to cause the client device to display and/or perform the recommended action. Described below are potential recommended actions based on the input and/or additional behavior information for the KBA challenge.

As shown in FIG. 1C, and by reference number 132-1, the client device may perform a first action based on a successful completion of the KBA challenge. For example, the client device may allow the application to be submitted to the server device. This may be a recommended action based on a fraud score that is indicative of little-to-no fraud. As shown in FIG. 1C, and by reference number 132-2, the client device may perform a second action based on an unsuccessful completion of the KBA challenge. For example, the client device may display a second authentication challenge. For example, the client device may display a notification to submit a video review, such as a video of the user saying a particular phrase, such as “banana.” As shown in FIG. 1C, and by reference number 132-3, the client device may transmit, to an operator device, the video review based on the unsuccessful completion of the KBA challenge. The operator device may determine whether the video review is sufficient to authenticate the user and/or accept the application.

As indicated above, FIGS. 1A-1C are provided as one or more examples. Other examples may differ from what is described in connection with FIGS. 1A-1C. The number and arrangement of devices shown in FIGS. 1A-1C are provided as one or more examples. In practice, there may be additional devices, fewer devices, different devices, or differently arranged devices than those shown in FIGS. 1A-1C. Furthermore, two or more devices shown in FIGS. 1A-1C may be implemented within a single device, or a single device shown in FIGS. 1A-1C may be implemented as multiple, distributed devices. Additionally, or alternatively, a set of devices (e.g., one or more devices) shown in FIGS. 1A-1C may perform one or more functions described as being performed by another set of devices shown in FIGS. 1A-1C.

FIG. 2 is a diagram illustrating an example 200 of training a machine learning model. The machine learning model training described herein may be performed using a machine learning system. The machine learning system may include a computing device, a server, a cloud computing environment, and/or the like, such as a fraud platform, a client device, an operator device, or a server device.

As shown by reference number 205, a machine learning model may be trained using a set of observations. The set of observations may be obtained and/or input from historical data, such as data gathered during one or more processes described herein. For example, the set of observations may include data gathered from user interaction with and/or user input to determine a fraud score, as described elsewhere herein. In some implementations, the machine learning system may receive the set of observations (e.g., as input) from a server device.

As shown by reference number 210, a feature set may be derived from the set of observations. The feature set may include a set of variable types. A variable type may be referred to as a feature. A specific observation may include a set of variable values corresponding to the set of variable types. A set of variable values may be specific to an observation. In some cases, different observations may be associated with different sets of variable values, sometimes referred to as feature values. In some implementations, the machine learning system may determine variable values for a specific observation based on input received from a server device. For example, the machine learning system may identify a feature set (e.g., one or more features and/or corresponding feature values) from structured data input to the machine learning system, such as by extracting data from a particular column of a table, extracting data from a particular field of a form, extracting data from a particular field of a message, extracting data received in a structured data format, and/or the like. In some implementations, the machine learning system may determine features (e.g., variables types) for a feature set based on input received from a server device, such as by extracting or generating a name for a column, extracting or generating a name for a field of a form and/or a message, extracting or generating a name based on a structured data format, and/or the like. Additionally, or alternatively, the machine learning system may receive input from an operator to determine features and/or feature values. In some implementations, the machine learning system may perform natural language processing and/or another feature identification technique to extract features (e.g., variable types) and/or feature values (e.g., variable values) from text (e.g., unstructured data) input to the machine learning system, such as by identifying keywords and/or values associated with those keywords from the text.

As an example, a feature set for a set of observations may include a first feature of whether a VPN is used, a second feature of a keystroke velocity, a third feature of whether a copy and paste action is detected, and so on. As shown, for a first observation, the first feature may have a value of “cannot be determined,” the second feature may have a value of “cannot be determined,” the third feature may have a value of “yes,” and so on. These features and feature values are provided as examples and may differ in other examples. For example, the feature set may include one or more of the following features: whether the client device communicates with the server device via a VPN, a type of VPN used by a client device to communicate with a server device, a network route that carries traffic between the client device and the server device, one or more network devices included in the network route, whether the network route includes an anonymity network exit node, an ISP associated with the client device, one or more cookies installed on the client device, one or more software applications installed on the client device, an operating system of the client device, a web browser used by the client device to access the application form, a device identifier associated with the client device, keystroke dynamics used to input data into one or more fields or to navigate between fields of the application form, mouse dynamics used to input data into one or more fields or to navigate between fields of the application form, a technique used to navigate between fields of the application form, a technique used to scroll between different portions of the application form on the client device, an amount of time spent completing one or more sections of the application form, a usage of uppercase or lowercase when inputting data into the one or more fields, a usage of copying and pasting when inputting data into one or more fields, and/or the like. In some implementations, the machine learning system may pre-process and/or perform dimensionality reduction to reduce the feature set and/or combine features of the feature set to a minimum feature set. A machine learning model may be trained on the minimum feature set, thereby conserving resources of the machine learning system (e.g., processing resources, memory resources, and/or the like) used to train the machine learning model.

As shown by reference number 215, the set of observations may be associated with a target variable type. The target variable type may represent a variable having a numeric value (e.g., an integer value, a floating point value, and/or the like), may represent a variable having a numeric value that falls within a range of values or has some discrete possible values, may represent a variable that is selectable from one of multiple options (e.g., one of multiple classes, classifications, labels, and/or the like), may represent a variable having a Boolean value (e.g., 0 or 1, True or False, Yes or No), and/or the like. A target variable type may be associated with a target variable value, and a target variable value may be specific to an observation. In some cases, different observations may be associated with different target variable values.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model, a predictive model, and/or the like. When the target variable type is associated with continuous target variable values (e.g., a range of numbers and/or the like), the machine learning model may employ a regression technique. When the target variable type is associated with categorical target variable values (e.g., classes, labels, and/or the like), the machine learning model may employ a classification technique.

In some implementations, the machine learning model may be trained on a set of observations that do not include a target variable (or that include a target variable, but the machine learning model is not being executed to predict the target variable). This may be referred to as an unsupervised learning model, an automated data analysis model, an automated signal extraction model, and/or the like. In this case, the machine learning model may learn patterns from the set of observations without labeling or supervision, and may provide output that indicates such patterns, such as by using clustering and/or association to identify related groups of items within the set of observations.

As further shown, the machine learning system may partition the set of observations into a training set 220 that includes a first subset of observations, of the set of observations, and a test set 225 that includes a second subset of observations of the set of observations. The training set 220 may be used to train (e.g., fit, tune, and/or the like) the machine learning model, while the test set 225 may be used to evaluate a machine learning model that is trained using the training set 220. For example, for supervised learning, the test set 225 may be used for initial model training using the first subset of observations, and the test set 225 may be used to test whether the trained model accurately predicts target variables in the second subset of observations. In some implementations, the machine learning system may partition the set of observations into the training set 220 and the test set 225 by including a first portion or a first percentage of the set of observations in the training set 220 (e.g., 75%, 80%, or 85%, among other examples) and including a second portion or a second percentage of the set of observations in the test set 225 (e.g., 25%, 20%, or 15%, among other examples). In some implementations, the machine learning system may randomly select observations to be included in the training set 220 and/or the test set 225.

As shown by reference number 230, the machine learning system may train a machine learning model using the training set 220. This training may include executing, by the machine learning system, a machine learning algorithm to determine a set of model parameters based on the training set 220. In some implementations, the machine learning algorithm may include a regression algorithm (e.g., linear regression, logistic regression, and/or the like), which may include a regularized regression algorithm (e.g., Lasso regression, Ridge regression, Elastic-Net regression, and/or the like). Additionally, or alternatively, the machine learning algorithm may include a decision tree algorithm, which may include a tree ensemble algorithm (e.g., generated using bagging and/or boosting), a random forest algorithm, a boosted trees algorithm, and/or the like. A model parameter may include an attribute of a machine learning model that is learned from data input into the model (e.g., the training set 220). For example, for a regression algorithm, a model parameter may include a regression coefficient (e.g., a weight). For a decision tree algorithm, a model parameter may include a decision tree split location, as an example.

As shown by reference number 235, the machine learning system may use one or more hyperparameter sets 240 to tune the machine learning model. A hyperparameter may include a structural parameter that controls execution of a machine learning algorithm by the machine learning system, such as a constraint applied to the machine learning algorithm. Unlike a model parameter, a hyperparameter is not learned from data input into the model. An example hyperparameter for a regularized regression algorithm includes a strength (e.g., a weight) of a penalty applied to a regression coefficient to mitigate overfitting of the machine learning model to the training set 220. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), may be applied by setting one or more feature values to zero (e.g., for automatic feature selection), and/or the like. Example hyperparameters for a decision tree algorithm include a tree ensemble technique to be applied (e.g., bagging, boosting, a random forest algorithm, a boosted trees algorithm, and/or the like), a number of features to evaluate, a number of observations to use, a maximum depth of each decision tree (e.g., a number of branches permitted for the decision tree), a number of decision trees to include in a random forest algorithm, and/or the like.

To train a machine learning model, the machine learning system may identify a set of machine learning algorithms to be trained (e.g., based on operator input that identifies the one or more machine learning algorithms, based on random selection of a set of machine learning algorithms, and/or the like), and may train the set of machine learning algorithms (e.g., independently for each machine learning algorithm in the set) using the training set 220. The machine learning system may tune each machine learning algorithm using one or more hyperparameter sets 240 (e.g., based on operator input that identifies hyperparameter sets 240 to be used, based on randomly generating hyperparameter values, and/or the like). The machine learning system may train a particular machine learning model using a specific machine learning algorithm and a corresponding hyperparameter set 240. In some implementations, the machine learning system may train multiple machine learning models to generate a set of model parameters for each machine learning model, where each machine learning model corresponds to a different combination of a machine learning algorithm and a hyperparameter set 240 for that machine learning algorithm.

In some implementations, the machine learning system may perform cross-validation when training a machine learning model. Cross validation can be used to obtain a reliable estimate of machine learning model performance using only the training set 220, and without using the test set 225, such as by splitting the training set 220 into a number of groups (e.g., based on operator input that identifies the number of groups, based on randomly selecting a number of groups, and/or the like) and using those groups to estimate model performance. For example, using k-fold cross-validation, observations in the training set 220 may be split into k groups (e.g., in order or at random). For a training procedure, one group may be marked as a hold-out group, and the remaining groups may be marked as training groups. For the training procedure, the machine learning system may train a machine learning model on the training groups and then test the machine learning model on the hold-out group to generate a cross-validation score. The machine learning system may repeat this training procedure using different hold-out groups and different test groups to generate a cross-validation score for each training procedure. In some implementations, the machine learning system may independently train the machine learning model k times, with each individual group being used as a hold-out group once and being used as a training group k−1 times. The machine learning system may combine the cross-validation scores for each training procedure to generate an overall cross-validation score for the machine learning model. The overall cross-validation score may include, for example, an average cross-validation score (e.g., across all training procedures), a standard deviation across cross-validation scores, a standard error across cross-validation scores, and/or the like.

In some implementations, the machine learning system may perform cross-validation when training a machine learning model by splitting the training set into a number of groups (e.g., based on operator input that identifies the number of groups, based on randomly selecting a number of groups, and/or the like). The machine learning system may perform multiple training procedures and may generate a cross-validation score for each training procedure. The machine learning system may generate an overall cross-validation score for each hyperparameter set 240 associated with a particular machine learning algorithm. The machine learning system may compare the overall cross-validation scores for different hyperparameter sets 240 associated with the particular machine learning algorithm, and may select the hyperparameter set 240 with the best (e.g., highest accuracy, lowest error, closest to a desired threshold, and/or the like) overall cross-validation score for training the machine learning model. The machine learning system may then train the machine learning model using the selected hyperparameter set 240, without cross-validation (e.g., using all of data in the training set 220 without any hold-out groups), to generate a single machine learning model for a particular machine learning algorithm. The machine learning system may then test this machine learning model using the test set 225 to generate a performance score, such as a mean squared error (e.g., for regression), a mean absolute error (e.g., for regression), an area under receiver operating characteristic curve (e.g., for classification), and/or the like. If the machine learning model performs adequately (e.g., with a performance score that satisfies a threshold), then the machine learning system may store that machine learning model as a trained machine learning model 245 to be used to analyze new observations, as described below in connection with FIG. 3.

In some implementations, the machine learning system may perform cross-validation, as described above, for multiple machine learning algorithms (e.g., independently), such as a regularized regression algorithm, different types of regularized regression algorithms, a decision tree algorithm, different types of decision tree algorithms, and/or the like. Based on performing cross-validation for multiple machine learning algorithms, the machine learning system may generate multiple machine learning models, where each machine learning model has the best overall cross-validation score for a corresponding machine learning algorithm. The machine learning system may then train each machine learning model using the entire training set 220 (e.g., without cross-validation), and may test each machine learning model using the test set 225 to generate a corresponding performance score for each machine learning model. The machine learning model may compare the performance scores for each machine learning model, and may select the machine learning model with the best (e.g., highest accuracy, lowest error, closest to a desired threshold, and/or the like) performance score as the trained machine learning model 245.

As indicated above, FIG. 2 is provided as an example. Other examples may differ from what is described in connection with FIG. 2. For example, the machine learning model may be trained using a different process than what is described in connection with FIG. 2. Additionally, or alternatively, the machine learning model may employ a different machine learning algorithm than what is described in connection with FIG. 2, such as a Bayesian estimation algorithm, a k-nearest neighbor algorithm, an a priori algorithm, a k-means algorithm, a support vector machine algorithm, a neural network algorithm (e.g., a convolutional neural network algorithm), a deep learning algorithm, and/or the like.

FIG. 3 is a diagram illustrating an example 300 of applying a trained machine learning model to a new observation. The new observation may be input to a machine learning system that stores a trained machine learning model 305. In some implementations, the trained machine learning model 305 may be the trained machine learning model 245 described above in connection with FIG. 2. The machine learning system may include a computing device, a server, a cloud computing environment, and/or the like, such as a fraud platform, a client device, a server device, and/or an operator device.

As shown by reference number 310, the machine learning system may receive a new observation (or a set of new observations), and may input the new observation to the machine learning model 305. As shown, the new observation may include a first feature of whether a VPN is used, a second feature of a keystroke velocity, a third feature of whether a copy and paste action is used, and so on, as an example. The machine learning system may apply the trained machine learning model 305 to the new observation to generate an output (e.g., a result). The type of output may depend on the type of machine learning model and/or the type of machine learning task being performed. For example, the output may include a predicted (e.g., estimated) value of target variable (e.g., a value within a continuous range of values, a discrete value, a label, a class, a classification, and/or the like), such as when supervised learning is employed. Additionally, or alternatively, the output may include information that identifies a cluster to which the new observation belongs, information that indicates a degree of similarity between the new observation and one or more prior observations (e.g., which may have previously been new observations input to the machine learning model and/or observations used to train the machine learning model), and/or the like, such as when unsupervised learning is employed.

In some implementations, the trained machine learning model 305 may predict a value of 90 for the target variable of “fraud score.” for the new observation, as shown by reference number 315. Based on this prediction (e.g., based on the value having a particular label/classification, based on the value satisfying or failing to satisfy a threshold, and/or the like), the machine learning system may provide a recommendation, such as to send another authentication challenge to verify identity. Additionally, or alternatively, the machine learning system may perform an automated action and/or may cause an automated action to be performed (e.g., by instructing another device to perform the automated action), such as to send a more difficult authentication challenge. As another example, if the machine learning system were to predict a value of 5 for the target variable of “fraud score,” then the machine learning system may provide a different recommendation (e.g., allow a user to submit an application form, allow a user to sign into a service) and/or may perform or cause performance of a different automated action. In some implementations, the recommendation and/or the automated action may be based on the target variable value having a particular label (e.g., classification, categorization, and/or the like), may be based on whether the target variable value satisfies one or more thresholds (e.g., whether the target variable value is greater than a threshold, is less than a threshold, is equal to a threshold, falls within a range of threshold values, and/or the like), and/or the like.

In some implementations, the trained machine learning model 305 may classify (e.g., cluster) the new observation in a cluster, as shown by reference number 320. The observations within a cluster may have a threshold degree of similarity. Based on classifying the new observation in the cluster, the machine learning system may provide a recommendation. Additionally, or alternatively, the machine learning system may perform an automated action and/or may cause an automated action to be performed (e.g., by instructing another device to perform the automated action). As another example, if the machine learning system were to classify the new observation in a cluster, then the machine learning system may provide a different recommendation and/or may perform or cause performance of a different automated action.

In this way, the machine learning system may apply a rigorous and automated process to detect fraud. The machine learning system enables recognition and/or identification of tens, hundreds, thousands, or millions of features and/or feature values for tens, hundreds, thousands, or millions of observations, thereby increasing an accuracy and consistency of detecting fraud relative to requiring computing resources to be allocated for tens, hundreds, or thousands of operators to manually detect fraud using the features or feature values.

As indicated above, FIG. 3 is provided as an example. Other examples may differ from what is described in connection with FIG. 3.

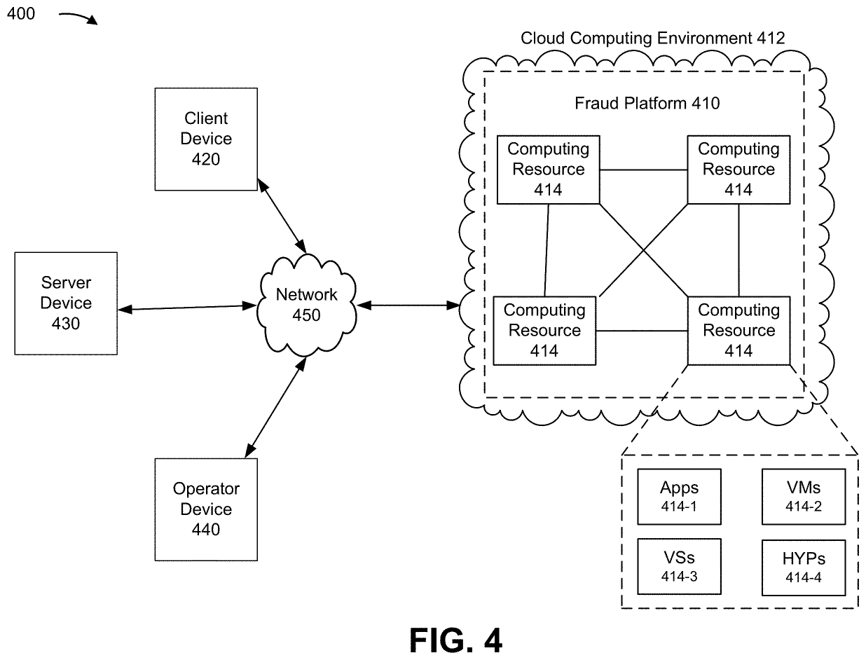

FIG. 4 is a diagram of an example environment 400 in which systems and/or methods, described herein, may be implemented. As shown in FIG. 4, environment 400 may include a fraud platform 410, a client device 420, a server device 430, an operator device 440, and/or a network 450. Devices of environment 400 may interconnect via wired connections, wireless connections, or a combination of wired and wireless connections.

Fraud platform 410 includes one or more devices that determine a fraud score based on receiving device information and/or behavior information. In some implementations, fraud platform 410 may be designed to be modular such that certain software components may be swapped in or out depending on a particular need. As such, fraud platform 410 may be easily and/or quickly reconfigured for different uses. In some implementations, fraud platform 410 may receive information from and/or transmit information to one or more client devices 420 and/or server devices 430.

In some implementations, as shown, fraud platform 410 may be hosted in a cloud computing environment 412. Notably, while implementations described herein describe fraud platform 410 as being hosted in cloud computing environment 421, in some implementations, fraud platform 410 may be non-cloud-based (i.e., may be implemented outside of a cloud computing environment) or may be partially cloud-based.

Cloud computing environment 412 includes an environment that hosts fraud platform 410. Cloud computing environment 412 may provide computation, software, data access, storage, etc. services that do not require end-user knowledge of a physical location and configuration of system(s) and/or device(s) that host fraud platform 410. As shown, cloud computing environment 412 may include a group of computing resources 414 (referred to collectively as “computing resources 414” and individually as “computing resource 414”).

Computing resource 414 includes one or more personal computers, workstation computers, server devices, and/or other types of computation and/or communication devices. In some implementations, computing resource 414 may host fraud platform 410. The cloud resources may include compute instances executing in computing resource 414, storage devices provided in computing resource 414, data transfer devices provided by computing resource 414, etc. In some implementations, computing resource 414 may communicate with other computing resources 414 via wired connections, wireless connections, or a combination of wired and wireless connections.

As further shown in FIG. 2, computing resource 414 includes a group of cloud resources, such as one or more applications (“APPs”) 414-1, one or more virtual machines (“VMs”) 414-2, virtualized storage (“VSs”) 414-3, one or more hypervisors (“HYPs”) 414-4, and/or the like.

Application 414-1 includes one or more software applications that may be provided to or accessed by client device 420. Application 414-1 may eliminate a need to install and execute the software applications on client device 420. For example, application 414-1 may include software associated with fraud platform 410 and/or any other software capable of being provided via cloud computing environment 412. In some implementations, one application 414-1 may send/receive information to/from one or more other applications 414-1, via virtual machine 414-2.

Virtual machine 414-2 includes a software implementation of a machine (e.g., a computer) that executes programs like a physical machine. Virtual machine 414-2 may be either a system virtual machine or a process virtual machine, depending upon use and degree of correspondence to any real machine by virtual machine 414-2. A system virtual machine may provide a complete system platform that supports execution of a complete operating system (“OS”). A process virtual machine may execute a single program and may support a single process. In some implementations, virtual machine 414-2 may execute on behalf of a user (e.g., a user of client device 420 and/or server device 430 or an operator of fraud platform 410), and may manage infrastructure of cloud computing environment 412, such as data management, synchronization, or long-duration data transfers.

Virtualized storage 414-3 includes one or more storage systems and/or one or more devices that use virtualization techniques within the storage systems or devices of computing resource 414. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 414-4 may provide hardware virtualization techniques that allow multiple operating systems (e.g., “guest operating systems”) to execute concurrently on a host computer, such as computing resource 414. Hypervisor 414-4 may present a virtual operating platform to the guest operating systems and may manage the execution of the guest operating systems. Multiple instances of a variety of operating systems may share virtualized hardware resources.

Client device 420 includes one or more devices capable of receiving, generating, storing, processing, and/or providing information, such as device information and/or behavior information described herein. For example, client device 420 may include a mobile phone (e.g., a smart phone, a radiotelephone, etc.), a laptop computer, a tablet computer, a desktop computer, a handheld computer, a gaming device, a wearable communication device (e.g., a smart wristwatch, a pair of smart eyeglasses, etc.), or a similar type of device. In some implementations, client device 420 may receive information from and/or transmit information to fraud platform 410 and/or server device 430.

Server device 430 includes one or more devices capable of receiving, generating, storing, processing, and/or providing information, such as information described herein. For example, server device 430 may include a laptop computer, a tablet computer, a desktop computer, a server device, a group of server devices, or a similar type of device, associated with a merchant, a financial institution, and/or the like. In some implementations, server device 430 may receive information from and/or transmit information to operator device 440, client device 420, and/or fraud platform 410.

Operator device 440 includes one or more devices capable of receiving, generating, storing, processing, and/or providing information, such as information described herein. For example, operator device 440 may include a laptop computer, a tablet computer, a desktop computer, a server device, a group of server devices, or a similar type of device, associated with a merchant, a financial institution, and/or the like. In some implementations, operator device 440 may receive information from and/or transmit information to server device 430 and/or fraud platform 410.

Network 450 includes one or more wired and/or wireless networks. For example, network 450 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or the like, and/or a combination of these or other types of networks.

The number and arrangement of devices and networks shown in FIG. 4 are provided as one or more examples. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

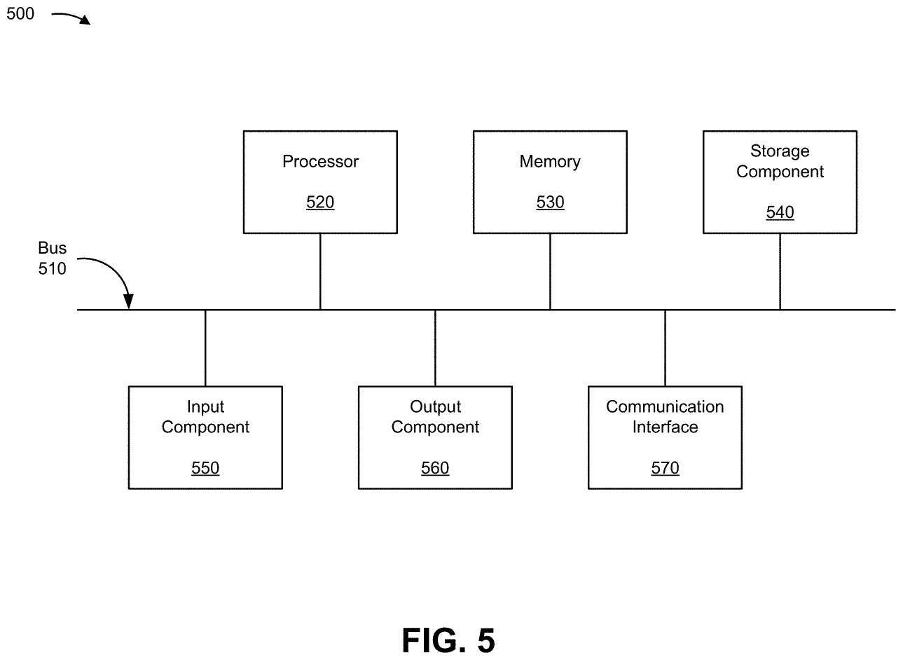

FIG. 5 is a diagram of example components of a device 500. Device 300 may correspond to fraud platform 410, client device 420, server device 430, and/or operator device 440. In some implementations, fraud platform 410, client device 420, server device 430, and/or operator device 440 may include one or more devices 500 and/or one or more components of device 500. As shown in FIG. 5, device 500 may include a bus 510, a processor 520, a memory 530, a storage component 540, an input component 550, an output component 560, and a communication interface 570.

Bus 510 includes a component that permits communication among multiple components of device 500. Processor 520 is implemented in hardware, firmware, and/or a combination of hardware and software. Processor 520 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 520 includes one or more processors capable of being programmed to perform a function. Memory 530 includes a random access memory (RAM), a read only memory (ROM), and/or another type of dynamic or static storage device (e.g., a flash memory, a magnetic memory, and/or an optical memory) that stores information and/or instructions for use by processor 520.

Storage component 540 stores information and/or software related to the operation and use of device 500. For example, storage component 540 may include a hard disk (e.g., a magnetic disk, an optical disk, and/or a magneto-optic disk), a solid state drive (SSD), a compact disc (CD), a digital versatile disc (DVD), a floppy disk, a cartridge, a magnetic tape, and/or another type of non-transitory computer-readable medium, along with a corresponding drive.

Input component 550 includes a component that permits device 500 to receive information, such as via user input (e.g., a touch screen display, a keyboard, a keypad, a mouse, a button, a switch, and/or a microphone). Additionally, or alternatively, input component 550 may include a component for determining location (e.g., a global positioning system (GPS) component) and/or a sensor (e.g., an accelerometer, a gyroscope, an actuator, another type of positional or environmental sensor, and/or the like). Output component 560 includes a component that provides output information from device 500 (via, e.g., a display, a speaker, a haptic feedback component, an audio or visual indicator, and/or the like).

Communication interface 570 includes a transceiver-like component (e.g., a transceiver, a separate receiver, a separate transmitter, and/or the like) that enables device 500 to communicate with other devices, such as via a wired connection, a wireless connection, or a combination of wired and wireless connections. Communication interface 570 may permit device 500 to receive information from another device and/or provide information to another device. For example, communication interface 570 may include an Ethernet interface, an optical interface, a coaxial interface, an infrared interface, a radio frequency (RF) interface, a universal serial bus (USB) interface, a Wi-Fi interface, a cellular network interface, and/or the like.

Device 500 may perform one or more processes described herein. Device 500 may perform these processes based on processor 520 executing software instructions stored by a non-transitory computer-readable medium, such as memory 530 and/or storage component 540. As used herein, the term “computer-readable medium” refers to a non-transitory memory device. A memory device includes memory space within a single physical storage device or memory space spread across multiple physical storage devices.

Software instructions may be read into memory 530 and/or storage component 540 from another computer-readable medium or from another device via communication interface 570. When executed, software instructions stored in memory 530 and/or storage component 540 may cause processor 520 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 5 are provided as an example. In practice, device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

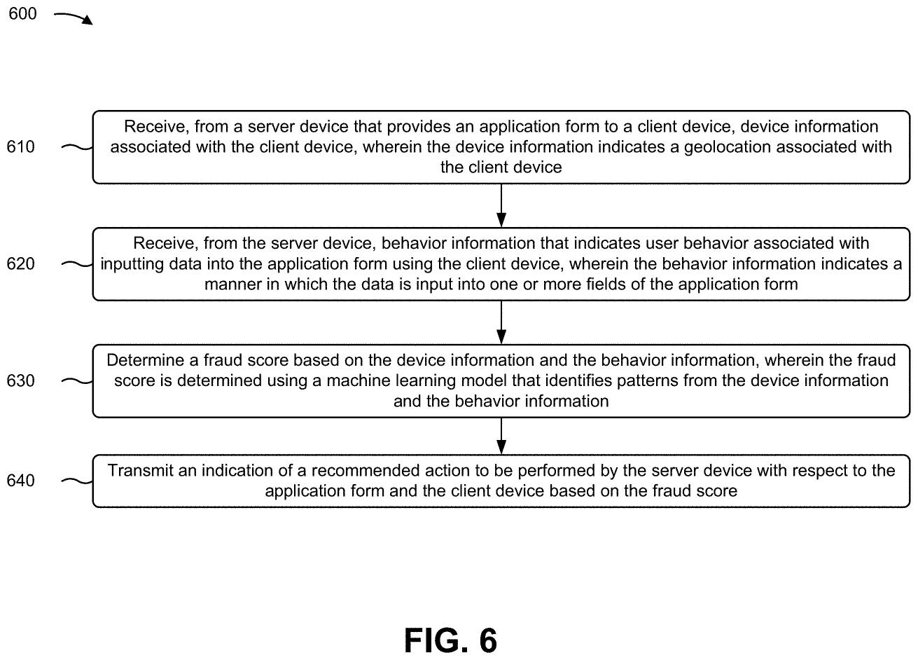

FIG. 6 is a flow chart of an example process 600 for fraud detection during an application process. In some implementations, one or more process blocks of FIG. 6 may be performed by a system (e.g., fraud platform 410). In some implementations, one or more process blocks of FIG. 6 may be performed by another device or a group of devices separate from or including the system, such as a client device (e.g., client device 420), a server device (e.g., server device 430), an operator device (e.g., operator device 440), and/or the like.

As shown in FIG. 6, process 600 may include receiving, from a server device that provides an application form to a client device, device information associated with the client device, wherein the device information indicates a geolocation associated with the client device, and wherein the device information indicates at least one of: whether the client device communicates with the server device via a virtual private network, a type of virtual private network used by the client device to communicate with the server device, a network route that carries traffic between the client device and the server device, one or more network devices included in the network route, whether the network route includes an anonymity network exit node, an Internet service provider associated with the client device, one or more cookies installed on the client device, one or more software applications installed on the client device, an operating system of the client device, a web browser used by the client device to access the application form, or a device identifier associated with the client device (block 610). For example, the system (e.g., using computing resource 414, processor 520, memory 530, storage component 540, input component 550, output component 560, communication interface 570, and/or the like) may receive, from a server device that provides an application form to a client device, device information associated with the client device, as described above. In some implementations, the device information indicates a geolocation associated with the client device. In some implementations, the device information indicates at least one of: whether the client device communicates with the server device via a virtual private network, a type of virtual private network used by the client device to communicate with the server device, a network route that carries traffic between the client device and the server device, one or more network devices included in the network route, whether the network route includes an anonymity network exit node, an Internet service provider associated with the client device, one or more cookies installed on the client device, one or more software applications installed on the client device, an operating system of the client device, a web browser used by the client device to access the application form, or a device identifier associated with the client device.

As further shown in FIG. 6, process 600 may include receiving, from the server device, behavior information that indicates user behavior associated with inputting data into the application form using the client device, wherein the behavior information indicates a manner in which the data is input into one or more fields of the application form (block 620). For example, the system (e.g., using computing resource 414, processor 520, memory 530, storage component 540, input component 550, output component 560, communication interface 570, and/or the like) may receive, from the server device, behavior information that indicates user behavior associated with inputting data into the application form using the client device, as described above. In some implementations, the behavior information indicates a manner in which the data is input into one or more fields of the application form.

As further shown in FIG. 6, process 600 may include determining a fraud score based on the device information and the behavior information, wherein the fraud score is determined using a machine learning model that identifies patterns from the device information and the behavior information (block 630). For example, the system (e.g., using computing resource 414, processor 520, memory 530, storage component 540, input component 550, output component 560, communication interface 570, and/or the like) may determine a fraud score based on the device information and the behavior information, as described above. In some implementations, the fraud score is determined using a machine learning model that identifies patterns from the device information and the behavior information.

As further shown in FIG. 6, process 600 may include transmitting an indication of a recommended action to be performed by the server device with respect to the application form and the client device based on the fraud score (block 640). For example, the system (e.g., using computing resource 414, processor 520, memory 530, storage component 540, input component 550, output component 560, communication interface 570, and/or the like) may transmit an indication of a recommended action to be performed by the server device with respect to the application form and the client device based on the fraud score, as described above.

Process 600 may include additional implementations, such as any single implementation or any combination of implementations described below and/or in connection with one or more other processes described elsewhere herein.

In a first implementation, the behavior information may indicate at least one of: keystroke dynamics used to input the data into the one or more fields or to navigate between fields of the application form, mouse dynamics used to input the data into the one or more fields or to navigate between fields of the application form, a technique used to navigate between fields of the application form, a technique used to scroll between different portions of the application form on the client device, usage of uppercase or lowercase when inputting the data into the one or more fields, or usage of copying and pasting when inputting the data into the one or more fields.

In a second implementation, alone or in combination with the first implementation, the device information and the behavior information each may include multiple parameters that are used as features for the machine learning model.

In a third implementation, alone or in combination with one or more of the first and second implementations, the recommended action may include a biometric step-up action, that requires an answer to a knowledge-based authentication question before a completed application form can be submitted to the server device, based on determining that the fraud score satisfies the threshold.

In a fourth implementation, alone or in combination with one or more of the first through third implementations, process 600 may include: receiving an answer to the knowledge-based authentication question, receiving additional behavior information that indicates user behavior associated with inputting information to the client device to answer the knowledge-based authentication question, updating the fraud score based on the answer and the additional behavior information, and transmitting an indication of another recommended action to be performed by the server device with respect to the application form and the client device based on the updated fraud score.

In a fifth implementation, alone or in combination with one or more of the first through fourth implementations, process 600 may include determining that the fraud score satisfies a threshold, and where the recommended action may include a video review action, that requires submission of a video before a completed application form can be submitted to the server device, based on determining that the fraud score satisfies the threshold.

In a sixth implementation, alone or in combination with one or more of the first through fifth implementations, process 600 may include: transmitting, to the server device for transmission to the client device, a passphrase to be output by the client device via an interface that provides the application form, receiving the video, and transmitting the video and the passphrase to an operator device.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

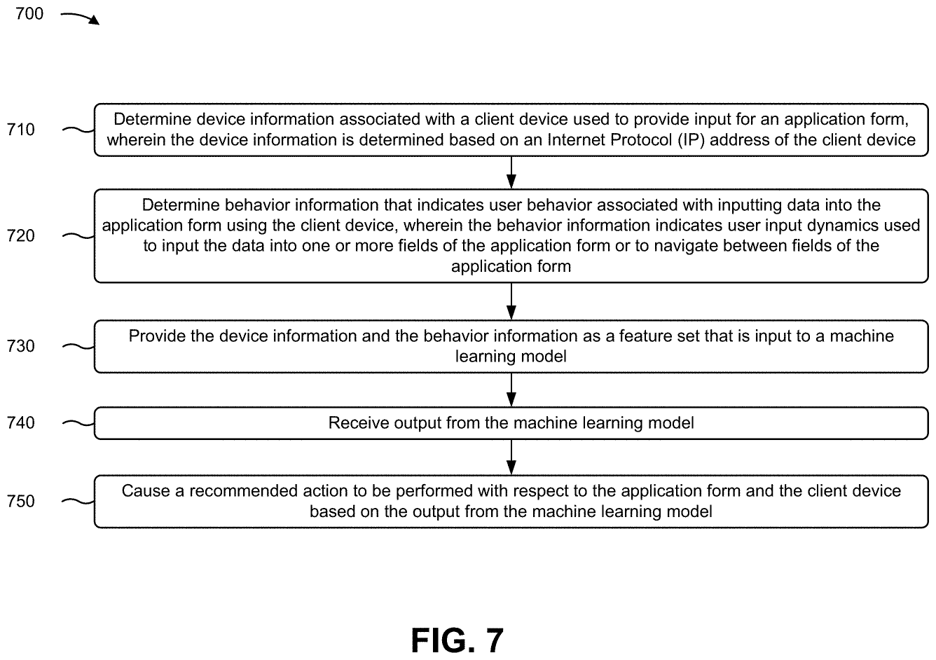

FIG. 7 is a flow chart of an example process 700 for fraud detection during an application process. In some implementations, one or more process blocks of FIG. 7 may be performed by a system (e.g., fraud platform 410). In some implementations, one or more process blocks of FIG. 7 may be performed by another device or a group of devices separate from or including the system, such as a client device (e.g., client device 420), a server device (e.g., server device 430), an operator device (e.g., operator device 440), and/or the like.

As shown in FIG. 7, process 700 may include determining device information associated with a client device used to provide input for an application form, wherein the device information is determined based on an Internet Protocol (IP) address of the client device (block 710). For example, the system (e.g., using computing resource 414, processor 520, memory 530, storage component 540, input component 550, output component 560, communication interface 570, and/or the like) may determine device information associated with a client device used to provide input for an application form, as described above. In some implementations, the device information is determined based on an Internet Protocol (IP) address of the client device.

As further shown in FIG. 7, process 700 may include determining behavior information that indicates user behavior associated with inputting data into the application form using the client device, wherein the behavior information indicates user input dynamics used to input the data into one or more fields of the application form or to navigate between fields of the application form (block 720). For example, the system (e.g., using computing resource 414, processor 520, memory 530, storage component 540, input component 550, output component 560, communication interface 570, and/or the like) may determine behavior information that indicates user behavior associated with inputting data into the application form using the client device, as described above. In some implementations, the behavior information may indicate user input dynamics used to input the data into one or more fields of the application form or to navigate between fields of the application form.

As further shown in FIG. 7, process 700 may include providing the device information and the behavior information as a feature set that is input to a machine learning model (block 730). For example, the system (e.g., using computing resource 414, processor 520, memory 530, storage component 540, input component 550, output component 560, communication interface 570, and/or the like) may provide the device information and the behavior information as a feature set that is input to a machine learning model, as described above.

As further shown in FIG. 7, process 700 may include receiving output from the machine learning model, wherein the output from the machine learning model is determined based on a degree of similarity of the feature set and at least one of: one or more other feature sets associated with labeled instances of fraud, or a threshold number of feature sets analyzed in connection with the application form or other application forms (block 740). For example, the system (e.g., using computing resource 414, processor 520, memory 530, storage component 540, input component 550, output component 560, communication interface 570, and/or the like) may receive output from the machine learning model, as described above. In some implementations, the output from the machine learning model is determined based on a degree of similarity of the feature set and at least one of one or more other feature sets associated with labeled instances of fraud, or a threshold number of feature sets analyzed in connection with the application form or other application forms.

As further shown in FIG. 7, process 700 may include causing a recommended action to be performed with respect to the application form and the client device based on the output from the machine learning model (block 750). For example, the system (e.g., using computing resource 414, processor 520, memory 530, storage component 540, input component 550, output component 560, communication interface 570, and/or the like) may cause a recommended action to be performed with respect to the application form and the client device based on the output from the machine learning model, as described above.

Process 700 may include additional implementations, such as any single implementation or any combination of implementations described below and/or in connection with one or more other processes described elsewhere herein.

In a first implementation, the recommended action may include one of: approving an application associated with the application form, rejecting the application, or requesting additional data from the client device.

In a second implementation, alone or in combination with the first implementation, process 700 may include determining that the feature set has a threshold degree of similarity with a group of feature sets obtained in connection with other instances of the application form or one or more other application form. In some implementations, the output from the machine learning model is based on determining that the feature set has the threshold degree of similarity with the group of feature sets obtained in connection with other instances of the application form or the one or more other application forms. In some implementations, process 700 may include transmitting information that identifies the other instances to an operator device.

In a third implementation, alone or in combination with one or more of the first and second implementations, the device information may be determined based on a hypertext transfer protocol request submitted by the client device.

In a fourth implementation, alone or in combination with one or more of the first through third implementations, process 700 may include determining that the fraud score satisfies a threshold. In some implementations, the recommended action may include a video review action, that requires submission of a video before a completed application form can be submitted to the server device, based on determining that the fraud score satisfies the threshold.

In a fifth implementation, alone or in combination with one or more of the first through fourth implementations, process 700 may include: transmitting, to the server device for transmission to the client device, a passphrase to be output by the client device via an interface that provides the application form, receiving the video, and transmitting the video and the passphrase to an operator device.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

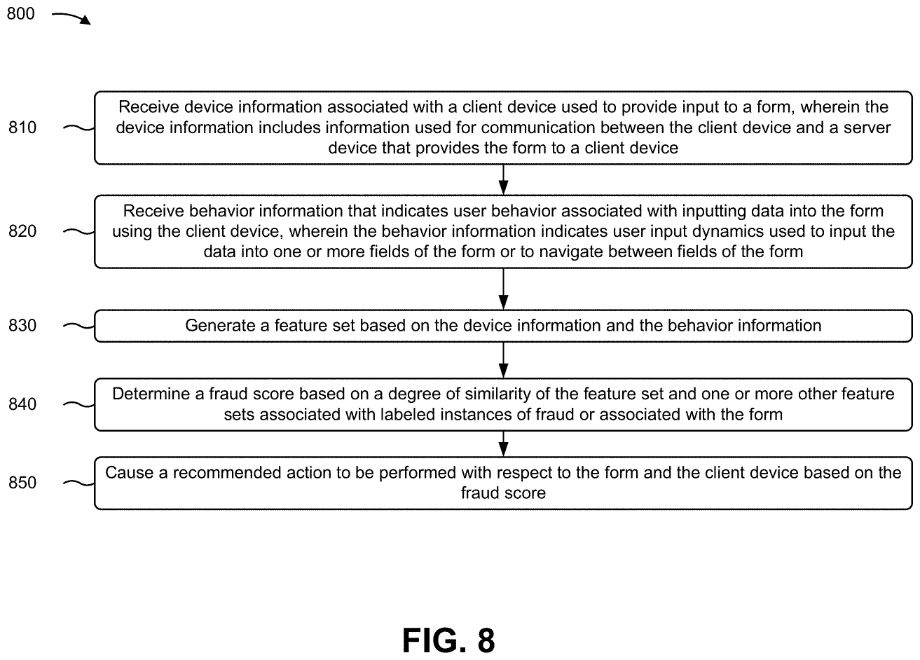

FIG. 8 is a flow chart of an example process 800 for fraud detection during an application process. In some implementations, one or more process blocks of FIG. 8 may be performed by a system (e.g., fraud platform 410). In some implementations, one or more process blocks of FIG. 8 may be performed by another device or a group of devices separate from or including the system, such as a client device (e.g., client device 420), a server device (e.g., server device 430), an operator device (e.g., operator device 440), and/or the like.

As shown in FIG. 8, process 800 may include receiving device information associated with a client device used to provide input to a form, wherein the device information includes information used for communication between the client device and a server device that provides the form to a client device (block 810). For example, the system (e.g., using computing resource 414, processor 520, memory 530, storage component 540, input component 550, output component 560, communication interface 570, and/or the like) may receive device information associated with a client device used to provide input to a form, as described above. In some implementations, the device information may include information used for communication between the client device and a server device that provides the form to a client device.

As further shown in FIG. 8, process 800 may include receiving behavior information that indicates user behavior associated with inputting data into the form using the client device, wherein the behavior information indicates user input dynamics used to input the data into one or more fields of the form or to navigate between fields of the form (block 820). For example, the system (e.g., using computing resource 414, processor 520, memory 530, storage component 540, input component 550, output component 560, communication interface 570, and/or the like) may receive behavior information that indicates user behavior associated with inputting data into the form using the client device, as described above. In some implementations, the behavior information may indicate user input dynamics used to input the data into one or more fields of the form or to navigate between fields of the form.

As further shown in FIG. 8, process 800 may include generating a feature set based on the device information and the behavior information (block 830). For example, the system (e.g., using computing resource 414, processor 520, memory 530, storage component 540, input component 550, output component 560, communication interface 570, and/or the like) may generate a feature set based on the device information and the behavior information, as described above.

As further shown in FIG. 8, process 800 may include determining a fraud score based on a degree of similarity of the feature set and one or more other feature sets associated with labeled instances of fraud or associated with the form (block 840). For example, the system (e.g., using computing resource 414, processor 520, memory 530, storage component 540, input component 550, output component 560, communication interface 570, and/or the like) may determine a fraud score based on a degree of similarity of the feature set and one or more other feature sets associated with labeled instances of fraud or associated with the form, as described above.

As further shown in FIG. 8, process 800 may include causing a recommended action to be performed with respect to the form and the client device based on the fraud score (block 850). For example, the system (e.g., using computing resource 414, processor 520, memory 530, storage component 540, input component 550, output component 560, communication interface 570, and/or the like) may cause a recommended action to be performed with respect to the form and the client device based on the fraud score, as described above.

Process 800 may include additional implementations, such as any single implementation or any combination of implementations described below and/or in connection with one or more other processes described elsewhere herein.

In a first implementation, the recommended action includes a biometric step-up action that requires an answer to a knowledge-based authentication question before a completed form can be submitted, and receive an answer to the knowledge-based authentication question; receive additional behavior information that indicates user behavior associated with inputting information to the client device to answer the knowledge-based authentication question; update the fraud score based on the answer and the additional behavior information; and cause another recommended action to be performed with respect to the form and the client device based on the updated fraud score.

In a second implementation, alone or in combination with the first implementation, the other recommended action includes a video review action, that requires submission of a video before a completed form can be submitted.

In a third implementation, alone or in combination with one or more of the first and second implementations, the behavior information indicates at least one of: keystroke dynamics used to input the data into the one or more fields or to navigate between fields of the form, mouse dynamics used to input the data into the one or more fields or to navigate between fields of the form, a technique used to navigate between fields of the form, a technique used to scroll between different portions of the form on the client device, usage of uppercase or lowercase when inputting the data into the one or more fields, or usage of copying and pasting when inputting the data into the one or more fields.

In a fourth implementation, alone or in combination with one or more of the first through third implementations, the device information indicates at least one of: whether the client device communicates with the server device via a virtual private network, a type of virtual private network used by the client device to communicate with the server device, a network route that carries traffic between the client device and the server device, one or more network devices included in the network route, whether the network route includes an anonymity network exit node, an Internet service provider associated with the client device, one or more cookies installed on the client device, one or more software applications installed on the client device, an operating system of the client device, a web browser used by the client device to access the form, or a device identifier associated with the client device.

In a fifth implementation, alone or in combination with one or more of the first through fourth implementations, the form is an application form associated with applying for credit.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

The foregoing disclosure provides illustration and description, but is not intended to be exhaustive or to limit the implementations to the precise form disclosed. Modifications and variations may be made in light of the above disclosure or may be acquired from practice of the implementations.

As used herein, the term “component” is intended to be broadly construed as hardware, firmware, or a combination of hardware and software.

Some implementations are described herein in connection with thresholds. As used herein, satisfying a threshold may, depending on the context, refer to a value being greater than the threshold, more than the threshold, higher than the threshold, greater than or equal to the threshold, less than the threshold, fewer than the threshold, lower than the threshold, less than or equal to the threshold, equal to the threshold, or the like.

Certain user interfaces have been described herein and/or shown in the figures. A user interface may include a graphical user interface, a non-graphical user interface, a text-based user interface, and/or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method, comprising:
receiving, by a system and from a server device that provides an application form to a client device, device information associated with the client device,
wherein the device information indicates a geolocation associated with the client device, and
wherein the device information indicates at least one of:
whether the client device communicates with the server device via a virtual private network,
a type of virtual private network used by the client device to communicate with the server device,
a network route that carries traffic between the client device and the server device,
one or more network devices included in the network route,
whether the network route includes an anonymity network exit node,
an Internet service provider associated with the client device,
one or more cookies installed on the client device,
one or more software applications installed on the client device,
an operating system of the client device,
a web browser used by the client device to access the application form, or
a device identifier associated with the client device;
receiving, by the system and from the server device, behavior information that indicates user behavior associated with inputting data into the application form using the client device,
wherein the behavior information indicates an input technique in which the data is input into one or more fields of the application form, and
wherein the behavior information is gathered by sensors of the client device;
inputting, by the system, one or more features of the behavior information or the device information into a machine learning model,
wherein the machine learning model is trained based on at least one of historical device information and historical behavioral information associated with the client device or a user associated with the client device;
clustering, by the system and using the machine learning model, the one or more features of the behavior information or the device information based on a threshold degree of similarity shared with other features of a cluster;
predicting, by the system and using the machine learning model, a target variable of a fraud score for the one or more features of the behavior information or the device information;
training, by the system and based on clustering the one or more features of the behavior information or the device information, the machine learning model; and
transmitting, by the system and based on clustering the one or more features of the behavior information or the device information, an indication of a recommended action to be performed by the server device with respect to the application form and the client device based on determining that the fraud score satisfies a threshold.

2. The method of claim 1, wherein the behavior information indicates at least one of:
keystroke dynamics used to input the data into the one or more fields or to navigate between the fields of the application form,
mouse dynamics used to input the data into the one or more fields or to navigate between the fields of the application form,
a technique used to navigate between the fields of the application form,
a technique used to scroll between different portions of the application form on the client device,
usage of uppercase or lowercase when inputting the data into the one or more fields, or
usage of a copying operation or a pasting operation when inputting the data into the one or more fields.

3. The method of claim 1, wherein the device information and the behavior information each include multiple parameters that are used as features for the machine learning model.

4. The method of claim 1, wherein the recommended action includes a biometric step-up action, that requires an answer to a knowledge-based authentication question before a completed application form can be submitted to the server device, based on determining that the fraud score satisfies the threshold.

5. The method of claim 4, further comprising:
receiving an answer to the knowledge-based authentication question;
receiving additional behavior information that indicates the user behavior associated with inputting information to the client device to answer the knowledge-based authentication question;
updating the fraud score based on the answer and the additional behavior information; and
transmitting an indication of another recommended action to be performed by the server device with respect to the application form and the client device based on the updated fraud score.

6. The method of claim 1, wherein the recommended action includes a video review action, that requires submission of a video before a completed application form can be submitted to the server device, based on determining that the fraud score satisfies the threshold.

7. The method of claim 6, further comprising:
transmitting, to the server device for transmission to the client device, a passphrase to be output by the client device via an interface that provides the application form;
receiving the video; and
transmitting the video and the passphrase to an operator device.

8. A system, comprising:
memory; and
one or more processors, communicatively coupled to the memory, configured to:
determine device information associated with a client device used to provide input for an application form,
wherein the device information is determined based on an Internet Protocol (IP) address of the client device;
determine behavior information that indicates user behavior associated with inputting data into the application form using the client device,
wherein the behavior information indicates user input dynamics used to input the data into one or more fields of the application form or to navigate between fields of the application form, and
wherein the behavior information is gathered by sensors of the client device;
provide the device information and the behavior information as a feature set that is input to a machine learning model,
wherein the machine learning model is trained on at least one of historical device information and historical behavioral information associated with the client device or a user associated with the client device;
cluster, using the machine learning model and into a cluster, the feature set based on a degree of similarity between the feature set and at least one of:
one or more feature sets associated with labeled instances of fraud, or
a threshold number of feature sets analyzed in connection with the application form or other application forms;
receive, based on clustering the feature set, output from the machine learning model,
wherein the output is determined based on the degree of similarity between the feature set and at least one of:
the one or more other feature sets associated with the labeled instances of fraud, or
the threshold number of feature sets analyzed in connection with the application form or the other application forms;
train, based on clustering the one or more features of the behavior information or the device information, the machine learning model; and
cause a recommended action to be performed with respect to the application form and the client device based on determining that the output satisfies a threshold.

9. The system of claim 8, wherein the recommended action includes one of: approving an application associated with the application form, rejecting the application, or requesting additional data from the client device.

10. The system of claim 8, further comprising determining that the feature set has a threshold degree of similarity with a group of feature sets obtained in connection with other instances of the application form or one or more other application forms; and
wherein the output from the machine learning model is based on determining that the feature set has the threshold degree of similarity with the group of feature sets obtained in connection with other instances of the application form or the one or more other application forms.

11. The system of claim 10, further comprising transmitting information that identifies the other instances to an operator device.

12. The system of claim 8, wherein the device information is determined based on a hypertext transfer protocol request submitted by the client device.

13. The system of claim 8, wherein the recommended action includes a video review action, that requires submission of a video before a completed application form can be submitted to a server device, based on determining that the output satisfies the threshold.

14. The system of claim 13, further comprising:
transmitting, to the server device for transmission to the client device, a passphrase to be output by the client device via an interface that provides the application form;
receiving the video; and
transmitting the video and the passphrase to an operator device.

15. A non-transitory computer-readable medium storing instructions, the instructions comprising:
one or more instructions that, when executed by one or more processors, cause the one or more processors to:
receive device information associated with a client device used to provide input to a form,
wherein the device information includes information used for communication between the client device and a server device that provides the form to the client device;
receive behavior information that indicates user behavior associated with inputting data into the form using the client device,
wherein the behavior information indicates user input dynamics used to input the data into one or more fields of the form or to navigate between fields of the form, and
wherein the behavior information is gathered by sensors of the client device;
generate a feature set based on the device information and the behavior information using a machine learning model,
wherein the machine learning model is trained on at least one of historical device information and historical behavioral information associated with the client device or a user associated with the client device;
cluster, using the machine learning model, the feature set based on a degree of similarity shared with other features of a cluster;
determine a fraud score based on a degree of similarity of the feature set and one or more other feature sets associated with labeled instances of fraud or associated with the form;
train, based on clustering the feature set and determining the fraud score, the machine learning model; and
cause a recommended action to be performed with respect to the form and the client device based on determining that the fraud score satisfies a threshold.

16. The non-transitory computer-readable medium of claim 15, wherein the recommended action includes a biometric step-up action that requires an answer to a knowledge-based authentication question before a completed form can be submitted; and
wherein the one or more processors, when executed by the one or more processors, further cause the one or more processors to:
receive an answer to the knowledge-based authentication question;
receive additional behavior information that indicates the user behavior associated with inputting information to the client device to answer the knowledge-based authentication question;
update the fraud score based on the answer and the additional behavior information; and
cause another recommended action to be performed with respect to the form and the client device based on the updated fraud score.

17. The non-transitory computer-readable medium of claim 16, wherein the other recommended action includes a video review action, that requires submission of a video before a completed form can be submitted.

18. The non-transitory computer-readable medium of claim 15, wherein the behavior information indicates at least one of:
keystroke dynamics used to input the data into the one or more fields or to navigate between the fields of the form,
mouse dynamics used to input the data into the one or more fields or to navigate between the fields of the form,
a technique used to navigate between the fields of the form,
a technique used to scroll between different portions of the form on the client device,
usage of uppercase or lowercase when inputting the data into the one or more fields, or
usage of a copying operation or a pasting operation when inputting the data into the one or more fields.

19. The non-transitory computer-readable medium of claim 15, wherein the device information indicates at least one of:
whether the client device communicates with the server device via a virtual private network,
a type of virtual private network used by the client device to communicate with the server device,
a network route that carries traffic between the client device and the server device,
one or more network devices included in the network route,
whether the network route includes an anonymity network exit node,
an Internet service provider associated with the client device,
one or more cookies installed on the client device,
one or more software applications installed on the client device,
an operating system of the client device,
a web browser used by the client device to access the form, or
a device identifier associated with the client device.

20. The non-transitory computer-readable medium of claim 15, wherein the form is an application form associated with applying for credit.
